(19) United States
(12) Patent Application Publication
(10) Pub. No.: US 2025/0178552 A1
(43) Pub. Date: Jun. 5, 2025

(54) BUMPER FOR A MOTOR VEHICLE

(71) Applicant: BENTELER AUTOMOBILTECHNIK GMBH, Paderborn (DE)

(72) Inventors: Andreas SCHILLER, Ehringhausen (DE); Wilhelm ARNS, Paderborn (DE); Elmar MOLLEMEIER, Delbrueck (DE)

(21) Appl. No.: 18/967,654

(22) Filed: Dec. 4, 2024

(30) Foreign Application Priority Data
Dec. 5, 2023 (EP) 23214360.2

(51) Int. Cl. B60R 19/18; B60R 19/24

(52) U.S. Cl. CPC B60R 19/18; B60R 19/24

(57) ABSTRACT

A bumper for a motor vehicle has a cross member and two crash boxes. The cross member has an upper leg and a lower leg, which are connected via a web. A crash box has a coupling section on the cross member side, which overlaps the upper leg or the lower leg and is joined thereto. According to the invention, the coupling section has a recess open on its front side. At least one wall section delimiting the recess is welded to the upper leg or the lower leg. An upper front web directed outward is adjacent to the upper leg. A lower front web directed outward is adjacent to the lower leg. In at least one front web, a bead oriented along the vehicle vertical axis can be provided in the area in front of a crash box.

The invention relates to a bumper for a motor vehicle according to the features in the preamble of claim 1.

Bumpers are installed as standard features on both the front and rear of motor vehicles in order to absorb impact energy from collision processes so that the supporting structure of the motor vehicle is not damaged as much as possible. Bumpers are also intended to help minimize injuries to people. A bumper has a cross member, which is fixable transversely to the longitudinal members of the motor vehicle frame by incorporating deformation elements in the form of crash boxes. The cross member is used to introduce the energy resulting from an impact into the crash boxes, where the impact energy is converted into deformation work. The arrangement of the bumper is coordinated in such a way that the crash boxes are positioned as centrally as possible on the longitudinal members of the vehicle and the impact energy is introduced into the crash boxes and thus also into the longitudinal control arms via the cross members with the lowest possible bending moment.

Bumpers have to meet the legal regulations as well as the requirements set for pedestrian protection. Good crash performance and a space-optimized and weight-optimized design are specifications here that are to be in accordance with the high demands on the safety structure of a motor vehicle. Strict safety requirements have to be met, which are tested via crash tests such as the so-called pole test or the RCAR bumper test.

A bumper with a cross member and two crash boxes is prior art from EP 1 928 704 B1. The cross member is profiled in a hat shape in cross section having a web and two legs. Each crash box has an upper coupling section and a lower coupling section on the cross member side. These overlap the upper leg or the lower leg and are joined thereto in each case.

US 2006/125254 A1 discloses a bumper for a motor vehicle having a cross member and crash boxes, wherein the cross member has an upper leg and a lower leg which are connected via a web. A crash box has a coupling section on the cross member side, which overlaps the upper leg and the lower leg and is joined thereto. The coupling section has an open recess on its front side. At least one wall section delimiting the recess is welded to the upper leg or the lower leg.

A comparable proposal is also disclosed in US 2022/0001818 A1.

A relatively deformable area is advantageous in the area of the connection between a crash box and the cross member. Otherwise, cracks and even tears can occur. The known solutions are not accompanied by the best conditions here.

Based on the prior art, the invention is based on the object of disclosing a functionally improved bumper for a motor vehicle, which has advantageous load and deformation behavior and is improved in particular with regard to the joint between the cross member and the crash box.

This object is achieved by a bumper according to claim 1.

Advantageous embodiments and developments of the bumper according to the invention form the subject matter of the dependent claims.

Embodiments and modifications of features of the motor vehicle bumper, which, individually or in combination, develop the bumper in a functional and technically advantageous manner can also be found in the description and the accompanying drawings.

Direction specifications refer to the installed position of the bumper in a motor vehicle and a vehicle coordinate system. A vehicle coordinate system is a three-dimensional Cartesian coordinate system for identifying the axes within a motor vehicle and of components of the motor vehicle. The x and y axes lie in a horizontal plane (=vehicle plane). The x-axis corresponds to the vehicle longitudinal axis, the y-axis corresponds to the vehicle transverse axis, and the z-axis corresponds to the vehicle vertical axis.

The bumper for a motor vehicle has a cross member and crash boxes. The cross member has an upper leg and a lower leg, which are connected via a web. A crash box has at least one coupling section on the cross member side, i.e. at its end directed toward the cross member. The coupling section overlaps the upper leg or the lower leg and is materially bonded thereto.

The coupling section has an open recess on its front side. At least one wall section delimiting the recess is welded to the upper leg or the lower leg.

This design enables joining that is advantageous in terms of manufacturing technology and a connection between the crash box and the cross member that is advantageous in terms of load and deformation behavior. The crash box and the cross member deform in the event of an impact in the attachment area of a crash box to a cross member. The cross member is stretched before the crash box without causing any cracks to develop.

Preferably, the coupling section is configured in a fork shape and has two prongs laterally delimiting the recess. The prongs extend to the right and left of the recess in the vehicle longitudinal axis (x axis). The prongs are welded to the leg of the cross member and stabilize and support it in the event of a crash.

The bumper according to the invention provides that the cross member has an outwardly directed upper front web adjacent to the upper leg and/or an outwardly directed lower front web adjacent to the lower leg, wherein the coupling section is joined to the upper front web or the lower front web.

In particular, the cross member has an upper front web and a lower front web. Furthermore, a crash box has an upper coupling section and a lower coupling section. The upper coupling section overlaps the upper leg of the cross member. The lower coupling section overlaps the lower leg of the cross member. At the front side, the coupling sections or the prongs of a coupling section support the legs and optionally the upper front web or the lower front web.

In an embodiment that is advantageous in practice, the upper coupling section and the lower coupling section can each be configured in a fork shape having a recess and two prongs laterally delimiting the recess. The prongs run in a straight line and extend over the upper leg or the lower leg to the upper front web or the lower front web, respectively, of the cross member.

A further embodiment provides that the upper coupling section has a recess that is open on the front side. The lower coupling section has a formation having lateral bevels and a bottom area in which a hole is provided. The hole has a circumferentially closed edge. The hole in the lower coupling section is not open on the front side. The lower coupling section is joined to the lower leg of the cross member via a hole weld.

The cross member is embodied as a closed hollow profile, at least over the majority of its length. In particular, the cross member has a middle length section, to which a connection section for a crash box is adjacent on both sides. At least in the middle length section and the connection sections for the crash boxes, the cross member is embodied as a hollow profile and has a closed interior.

The cross member can be an extruded profile having at least one hollow chamber extending in its longitudinal direction.

A design which is advantageous in practice provides that the cross member has a shell body which is configured as U-shaped or hat-shaped in cross section and a closing plate arranged on the front side of the shell body.

Due to the shell construction, the cross-sectional course of the hollow profile of the cross member is designed to withstand the load over the component length and advantageously has a greater depth in the middle length section than in the connection sections and/or end sections. The cross member height, i.e. the width of the web and/or front webs, can also differ and be adapted to compatibility and/or crash test requirements.

The shell body and the closing plate consist of steel. In particular with regard to crash performance, the shell body can consist of an ultra-high-strength steel material (UHSS) or can be a press-hardened steel component made of a manganese-boron steel. The closing plate is preferably made of medium-strength or high-strength steel. The shell body has a tensile strength of greater than 1,250 MPa. The closing plate has a tensile strength between 400 MPa and 1,200 MPa. For a thermoformed and press-hardened shell body, the tensile strength is greater than 1,450 MPa.

An embodiment which improves the bumper according to the invention, in particular in terms of deformation behavior, provides that the upper front web and/or the lower front web in the area in front of a crash box has a bead oriented in the vehicle vertical axis (z axis). The beading of the cross member in at least one front web can be efficiently integrated into the manufacturing and provides the cross member with deformability without making the inside of a crash box softer.

According to the invention, the bead is provided in an area of the cross member in front of a crash box. In particular, the bead is arranged in front of the recess in a coupling section.

A bead in one or both of the front webs effectively contributes to improving the deformability of the bumper system. Especially for the “pole center” load case, the deformation behavior of the bumper in a crash is improved. The cross member is stretched in the connection area in front of a crash box. The crash boxes tilt inwards. Crack formation and crack propagation are counteracted, in particular in or starting from the joint between a severely deforming cross member and a crash box.

Preferably, the bead is formed in the direction toward the crash box. The bead is furthermore advantageously laterally offset in the vehicle transverse access (y axis) in relation to a central longitudinal axis of a crash box. In particular, the bead is offset inward in the direction of the inner prong of the coupling section.

Preferably, the bead extends over the entire height of a front web. The height of the front web is measured along the vehicle vertical axis (z axis) in this case. The bead extends over the height of the front web and preferably merges into the transition between the front web and the upper leg or lower leg.

The bead has a width measured along the vehicle transverse axis (y-axis) of less than 30 mm, in particular less than 20 mm.

The front closing plate extends in the longitudinal direction of the cross member. The closing plate covers the bead in this case. The closing plate can extend in a straight line over the bead. It is also possible that the closing plate has a formation in the area of the bead, which engages with the bead in a front web.

The closing plate can have one or more beads. Beads can extend in the longitudinal direction or in the transverse direction of the closing plate.

It is also possible to provide a locally softened or soft zone instead of beads or in addition to beads in the closing plate or in the cross member, in particular in the legs of the cross member or a or each front web, with the goal of adjusting the deformation and load behavior of the bumper and in particular adapting it to compatibility and/or crash test requirements.

The invention is described in more detail hereinafter on the basis of drawings. In the figures:

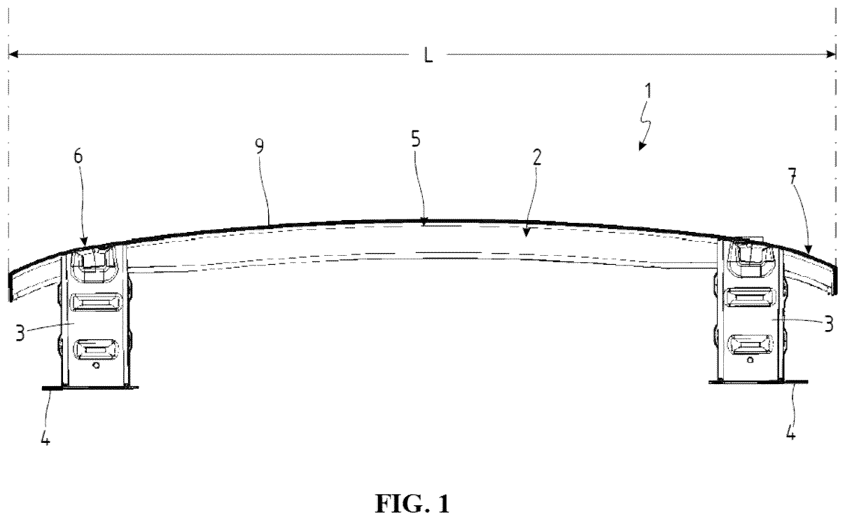

FIG. 1 shows a bumper according to the invention in a top view;

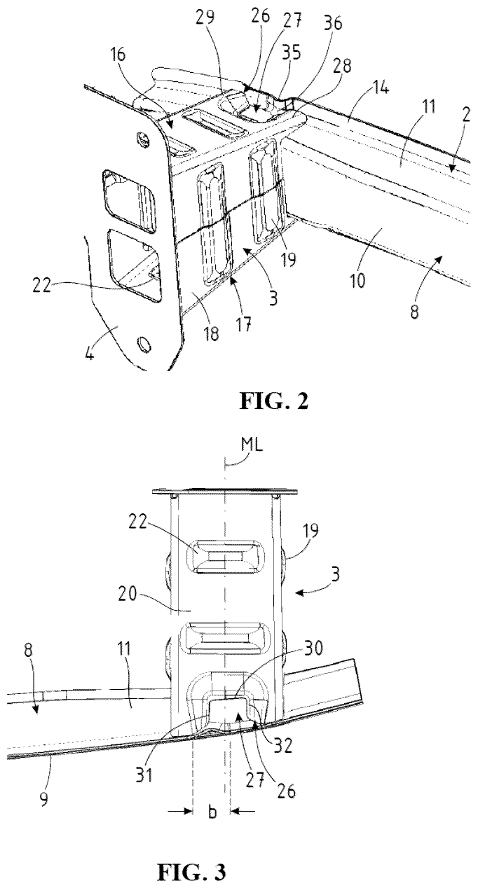

FIG. 2 shows a detail of the bumper with a perspective view of a crash box and the connection section of the cross member;

FIG. 3 shows the detail corresponding to the representation in FIG. 2 in a top view;

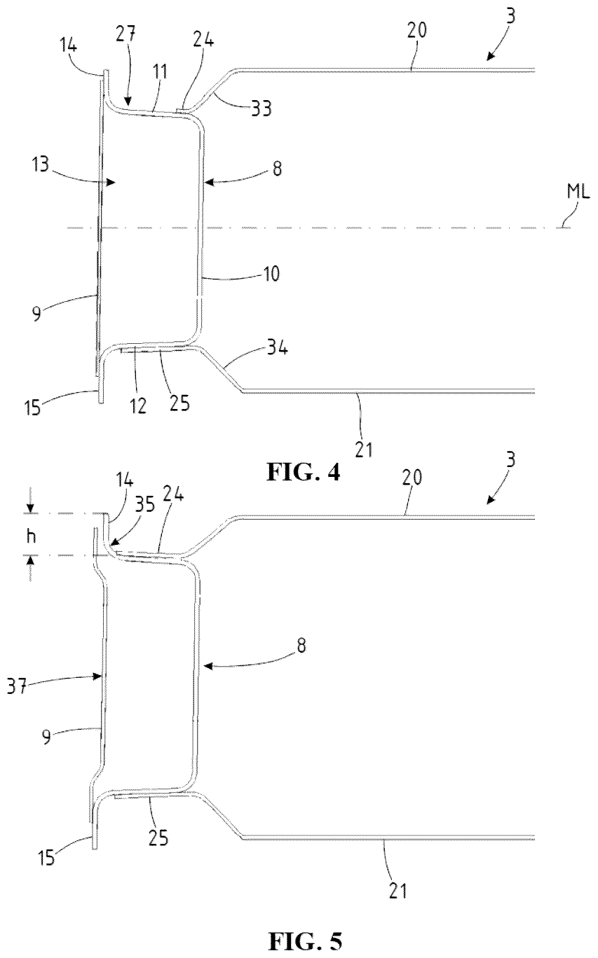

FIG. 4 technically schematically shows a vertical cross section through a crash box in the area of a recess in the upper coupling section of the crash box; and

FIG. 5 also technically schematically shows a vertical cross section through the crash box in the area of a bead in the upper front web.

FIG. 1 shows a bumper 1 according to the invention. A bumper 1 is used in the front or rear area of the body of a motor vehicle.

The bumper 1 has a cross member 2, which extends along the vehicle transverse axis (y axis) and is fixable transversely to longitudinal members of a motor vehicle, not shown here. The bumper 1 is supported on the longitudinal members via the crash boxes 3, with the inclusion of a flange plate 4 on each longitudinal member side. The connection between the bumper 1 and the motor vehicle is established via the flange plates 4. In addition to the cross member 2, the crash boxes 3 are intended to absorb the energy resulting from an impact, in particular at low speed, by converting it into deformation work.

The cross member 2 has a middle length section 5, to which a connection section 6 for a crash box 3 and an end section 7 are adjacent on both sides.

The cross member 2 has a shell body 8 that is open at the front and is closed by a closing plate 9 extending over the length of the shell body 8. The shell body 8 is configured with a U-shaped or hat-shaped cross section and has a web 10 as well as an upper leg 11 and a lower leg 12 (see also FIGS. 2 to 5 in this regard). The web 10 is arranged on the side of the bumper 1 facing toward the motor vehicle and connects the upper leg 11 and the lower leg 12. The upper leg 11 and the lower leg 12 are each directed forwards in the vehicle longitudinal direction, starting from the web 10.

Due to the closing plate 9, the cross member 2 is embodied as a closed hollow profile 13 over its length L.

An upper front web 14 directed outward is adjacent to the upper leg 11. A lower front web 15 directed outward is adjacent to the lower leg 12. The upper front web 14 and the lower front web 15 are oriented in the vehicle vertical axis (z axis), wherein the upper front web 14 is directed upward starting from the upper leg 11 and the lower front web 15 is directed downward starting from the lower leg 12. The closing plate 9 abuts the upper front web 14 and the lower front web 15 and is materially bonded thereto.

A crash box 3 is constructed in a shell design from two shell parts 16, 17. The shell parts 16, 17 are configured to match one another and preferably overlap at the ends of their side walls 18. Here, the shell parts 16, 17 are materially bonded to one another. In the side walls 18 of a crash box 3, vertical beads 19 oriented in the vehicle vertical axis (z axis) are provided. Furthermore, a crash box 3 has an upper wall 20 and a lower wall 21. In the upper wall 20, as well as in the lower wall 21, beads 22 are embossed which run in the vehicle transverse direction (y axis). The beads 19 in the side walls 18 are formed outward from the interior of a crash box 3. The beads 22 in the upper wall 20 and in the lower wall 21 are formed directed inward into the interior of a crash box 3.

In the connection section 6, a crash box 3 is connected to the cross member 2. On the cross member side, at its end 23 directed toward the cross member 2, a crash box 3 has a coupling section 24, 25 in extension of the upper wall 20 and the lower wall 21, respectively. The upper coupling section 24 overlaps the upper leg 11 of the cross member 2. The lower coupling section 25 overlaps the lower leg 12 of the cross member 2. In the coupling sections 24, 25, the crash box 3 is materially bonded to the cross member 2. This is done by welding.

In the illustrated exemplary embodiment, the upper coupling section 24 has a recess 27 open on its front side 26. The coupling section 24 is configured in a fork shape and has two prongs 28, 29 laterally delimiting the recess 27. The prongs 28, 29 extend in extension of the upper wall 20 up to the upper front web 14 and support the upper leg 11 and the upper front web 14 in the event of a frontal impact. This ensures that in the event of a frontal impact with an obstacle at a different height, even with a small vertical overlap, a good load introduction and a good force level for the targeted deformation of the crash box 3 is achieved. The prongs 28, 29 are welded to the leg 11.

In an embodiment in which the lower coupling section 25 is also configured in a fork shape, having a recess and two prongs laterally delimiting the recess, the prongs support the lower leg 12 and the lower front web 15.

The recess 27 is delimited by a wall section 29 oriented in the vehicle transverse axis (y axis) and two wall sections 31, 32 oriented to the left and right of the recess 27 in the vehicle longitudinal axis (x axis). The coupling section 24 is welded to the upper leg 11 at least on one wall section 30, 31, 32, in particular on all three wall sections 30, 31, 32. Furthermore, the coupling section 24 can be welded to the upper front web 14 on the front side of the prongs 28, 29.

As shown in particular in FIGS. 4 and 5, the upper wall 20 of the crash box 3 merges into the upper coupling section 24 via an inclined transition section 33 which is retracted towards the central longitudinal axis ML of the crash box 3. The lower wall 21 of the crash box 3 also merges into the lower coupling section 25 via a retracted transition section 34 which runs at an incline in the direction of the central longitudinal axis ML of the crash box 3. The transition section 33 merges into the two prongs 28, 29 running in straight lines, as can be seen in FIGS. 2 and 3.

In the area in front of a crash box 3, the upper front web 14 has a bead 35. The bead 35 is oriented along the vehicle vertical axis (z axis) and arranged in the area in front of the recess 27. The bead 35 is formed in the direction toward the crash box 3. In particular, from the illustration in FIG. 3, it can be seen that the bead 35 is laterally offset in relation to the central longitudinal axis ML of a crash box 3 in the vehicle transverse axis (y axis). The bead 33 is offset laterally in relation to the vehicle center in the direction toward the inner prong 28.

The bead 35 extends over the height h of the upper front web 14 measured in the vehicle vertical axis (z axis) up to the transition 36 between the upper front web 14 and the upper leg 11. The bead 35 has a width b measured in the vehicle transverse axis (y axis) which is less than 30 mm, in particular less than 20 mm.

The closing plate 9 extends along the front of the shell body 8 and covers the bead 35. The closing plate 9 can run in a straight line along the front. This is shown in the illustration in FIG. 5. The closing plate 9 can also have one or more beads, in particular the closing plate 9 can have a bead-shaped formation 37 which is provided in the area of the bead 35 in the upper front web 14.

### Reference Signs

1—bumper
2—cross member
3—crash box
4—flange plate
5—middle length section
6—connection section
7—end section
8—shell body
9—closing plate
10—web
11—upper leg
12—lower leg
13—hollow profile
14—upper front web
15—lower front web
16—shell part
17—shell part
18—side wall of 16, 17
19—bead
20—upper wall of 3
21—lower wall of 3
22—bead
23—end of 3
24—coupling section
25—coupling section
26—front side of 24
27—recess
28—prong
29—prong
30—wall section of 27
31—wall section of 27
32—wall section of 27
33—transition section
34—transition section
35—bead
36—transition
37—formation
b—width
H—height
L—length
ML—central longitudinal axis

1-12. (canceled)

13. A bumper for a motor vehicle having a cross member and crash boxes, wherein the cross member has an upper leg and a lower leg which are connected via a web and a crash box has a coupling section on the cross member side which overlaps the upper leg or the lower leg and is joined thereto, wherein the coupling section has a recess open on its front side and at least one wall section delimiting the recess is welded to the upper leg or the lower leg and the cross member has an outwardly directed upper front web adjacent to the upper leg and/or an outwardly directed lower front web adjacent to the lower leg, characterized in that the upper front web and/or the lower front web has a bead in the area in front of a crash box.

14. The bumper according to claim 13, wherein the coupling section is fork-shaped and has two prongs laterally delimiting the recess.

15. The bumper according to claim 14, wherein the coupling section is joined to the upper front web or the lower front web.

16. The bumper according to claim 13, wherein the cross member is embodied as a closed hollow profile at least over the majority of its length.

17. The bumper according to claim 13, wherein the cross member has a shell body configured in a U-shaped or hat-shaped cross section and a closing plate arranged on the front side of the shell body.

18. The bumper according to claim 13, wherein the bead is oriented along the vehicle vertical axis.

19. The bumper according to claim 13, wherein the bead is arranged in front of the recess.

20. The bumper according to claim 13, wherein the bead is formed in the direction toward the crash box.

21. The bumper according to claim 13, wherein the bead is laterally offset in the vehicle transverse axis with respect to the central longitudinal axis of a crash box.

22. The bumper according to claim 13, wherein a front web has a height measured along the vehicle vertical axis and the bead extends over the height.

23. The bumper according to claim 13, wherein the bead has a width measured along the vehicle transverse axis of less than 30 mm, in particular less than 20 mm.

24. The bumper according to claim 17, wherein the closing plate covers the bead.
